(19) United States
(12) Patent Application Publication
(10) Pub. No.: US 2010/0079650 A1
(43) Pub. Date: Apr. 1, 2010

(54) IMAGING APPARATUS AND METHOD FOR DRIVING SOLID-STATE IMAGING ELEMENT

(75) Inventor: Takashi GOTO, Kanagawa (JP)

Correspondence Address: Studebaker & Brackett PC, One Fountain Square, 11911 Freedom Drive, Suite 750, Reston, VA, 20190, US

(73) Assignee: FUJIFILM CORPORATION, Tokyo (JP)

(21) Appl. No.: 12/568,530

(22) Filed: Sep. 28, 2009

(30) Foreign Application Priority Data
Sep. 29, 2008 (JP) P2008-251884

(51) Int. Cl. H04N 5/335

(52) U.S. Cl. 348/308; 348/E05.091

(57) ABSTRACT

In an imaging apparatus equipped with a solid-state imagining element includes: a photoelectric converting portion; a floating gate provided above a semiconductor substrate, for storing thereinto electric charges generated in the photoelectric converting portion; and a writing transistor for injecting the electric charges generated in the photoelectric converting portion into the floating gate, the solid-state imaging element is further comprised of: a control portion for driving a writing transistor in such a manner that injecting of the electric charges generated in the photoelectric converting portion into the floating gate is stopped during an exposing time period, and after the exposing time period has accomplished, the electric charges generated in the photoelectric converting portion during the exposing time period are injected into the floating gate.

The present application claims priority from Japanese Patent Application No. 2008-251884 filed on Sep. 29, 2008, the entire content of which is incorporated herein by reference.

### BACKGROUND OF INVENTION

1. Field of the Invention

The present invention is related to an imaging apparatus equipped with a solid-state imaging element having: a photoelectric converting portion; an electric charge storage portion provided above a semiconductor substrate, for storing thereinto electric charges generated in the photoelectric converting portion; and a transistor for injecting the electric chares generated in the photoelectric converting portion into the electric charge storage portion.

2. Description of the Related Art

A solid-state imaging apparatus for performing an imaging operation in the following manner has been proposed (refer to JP-A-2002-280537): That is, in the above-described solid-state imaging apparatus, electric charges generated in a photoelectric converting element such as a photodiode (PD) are injected into a floating gate (FG) of a MOS transistor, which functions as an electric charge storage portion, so as to be stored in the floating gate (FG), and then, signals responding to the electric charges stored in the FG are read out from the first-mentioned MOS transistor by another MOS transistor.

In the imaging apparatus described in JP-A-2002-280537, storing (exposing) of electric charges into the PD (Photodiode), and writing of electric charges which have been stored in the PD into the FG (floating gate) are carried out at the same time. During an exposing time period, a high voltage is continuously applied to a gate of a writing-purpose MOS transistor. As a result, there are large possibilities that noises generated during the exposing time period, more specifically, a dark current produced from a drain of the writing-purpose MOS transistor may also be written into the FG during the exposing time period.

Assuming now that noises per unit time are defined as “N”, which are caused by the dark current produced from the writing-purpose MOS transistor, noises which are mixed into the FG (floating gate) become (N X exposing time). As a consequence, in particular, when the exposing operation is carried out for a long time, there is such a risk that image qualities may be deteriorated. Although such a description has been made in the paragraph of JP-A-2002-280537 that the electric charges may be merely stored in the PD at the initial stage of the exposing time period, and the electric charges may be alternatively written into the FG in a half way of the exposing time period, noises which are mixed into the FG become (N X (exposing time period-initial time of exposing time period)) even in such an alternative case. Accordingly, adverse influences caused by the noises still remain.

### SUMMARY OF INVENTION

The present invention has been made to solve the above-described problem, and therefore, has an object to provide an imaging apparatus and a method of driving a solid-state imaging element, capable of performing a high image-quality imaging operation by suppressing noises.

An imaging apparatus, according to an aspect of the present invention, is featured by such an imaging apparatus equipped with a solid-state imaging element comprising: a photoelectric converting portion; an electric charge storage portion provided above a semiconductor substrate, for storing thereinto electric charges generated in the photoelectric converting portion; and a transistor for injecting the electric charges generated in the photoelectric converting portion into the electric charge storage portion; which is further comprised of: driving unit for driving the transistor in such a manner that injecting of the electric charges generated from the photoelectric converting portion into the electric charge storage portion is stopped during an exposing time period, and after the exposing time period has accomplished, the electric charges generated in the photoelectric converting portion during the exposing time period are injected into the electric charge storage portion.

With employment of the above-described structure, since injecting of the electric charges into the electric charge storage unit is not carried out during the exposing time period, such a possibility that noises produced during the exposing time period are mixed in the electric charge storage unit can be lowered. Also, injecting of the electric charges into the electric charge storage unit which have been generated during the exposing time period can be carried out within a sufficiently shorter time than the exposing time period. As a consequence, mixing of the noises into the electric charge storage unit within a time period during which the electric charges are injected can be reduced to a negligibly low noise. As a result, the imaging operation with the high image quality can be carried out, while suppressing the noises.

In the imaging apparatus of the present invention, the solid-state imaging element is further comprised of a reading transistor for reading a signal which responds to the electric charges stored in the electric charge storage portion; the electric charge storage portion is a floating gate; and the floating gate contained in the transistor is connected to the floating gate contained in the reading transistor.

With employment of the above-described structure, since the noise generating source is increased due to the reading transistor, the noise suppression effect can be more conspicuously achieved.

In the imaging apparatus of the present invention, the driving unit drives the transistor in such a manner that the electric charges are injected based upon a channel hot electron injection.

In the imaging apparatus of the present invention, the driving unit drives the transistor in such a manner that the electric charges are injected based upon a tunnel electron injection.

In the imaging apparatus of the present invention, the photoelectric converting portion is a photoelectric converting film provided above the semiconductor substrate.

In the imaging apparatus of the present invention, the photoelectric converting film is constructed by amorphous silicon, a CIGS (copper, indium, gallium, selenium)-series material, or an organic material.

A driving method of a solid-state imaging element, according to another aspect of the present invention, is featured that in such a method of driving a solid-state imaging element having: a photoelectric converting element; an electric charge storage portion provided above a semiconductor substrate, for storing thereinto electric charges generated in the photoelectric converting portion; and a transistor for injecting the electric charges generated in the photoelectric converting portion into the electric charge storage portion; the driving method of the solid-state imaging element is comprised of: a driving step for driving the transistor in such a manner that injecting of the electric charges generated in the photoelectric converting portion into the electric charge storage portion is stopped during an exposing time period, and after the exposing time period has accomplished, the electric charges generated in the photoelectric converting portion during the exposing time period are injected into the electric charge storage portion.

In the driving method of the solid-state imaging element according to the present invention, the solid-state imaging element is further provided with a reading transistor for reading a signal which responds to the electric charges stored in the electric charge storage portion; the electric charge storage portion is a floating gate; and the floating gate contained in the transistor is connected to the floating gate contained in the reading transistor.

In the driving method of the solid-state imaging element according to the present invention, the writing transistor is driven in such a manner that the electric charges are injected based upon a channel hot electron injection.

In the driving method of the solid-state imaging element according to the present invention, the writing transistor is driven in such a manner that the electric charges are injected based upon a tunnel electron injection.

In the driving method of the solid-state imaging element according to the present invention, the photoelectric converting portion is a photoelectric converting film provided above the semiconductor substrate.

In the driving method of the solid-state imaging element according to the present invention, the photoelectric converting film is constructed by amorphous silicon, a CIGS (copper, indium, gallium, selenium)-series material, or an organic material.

In accordance with the present invention, the imaging apparatus and the driving method of the solid-state imaging element is capable of performing a high image-quality imaging operation by suppressing noises.

### BRIEF DESCRIPTION OF THE DRAWINGS

FIGS. 1A and 1B are a schematic diagram for schematically showing a structure of a solid-state imaging element in order to describe an embodiment mode of the present invention;

FIG. 2 is a sectional view for schematically representing a structure of a pixel portion indicated in FIG. 1A;

FIG. 3 is an equivalent circuit diagram of the pixel portion shown in FIG. 1A.

FIG. 4 is a timing chart for describing a first example as to imaging operations of an imaging apparatus on which the solid-state imaging element indicated in FIG. 1A is mounted;

FIG. 5 is a timing chart for describing a second example as to imaging operations of an imaging apparatus on which the solid-state imaging element indicated in FIG. 1A is mounted; and

FIG. 6 is a sectional view for schematically indicating another structural example as to the pixel portion of the solid-state imaging element represented in FIG. 1A.

### DESCRIPTION OF EXEMPLARY EMBODIMENTS

A description is made of a solid-state imaging element in order to explain one embodiment mode of the present invention with reference to drawings. The above-described solid-state imaging element is mounted on an imaging apparatus such as a digital camera and a digital video camera.

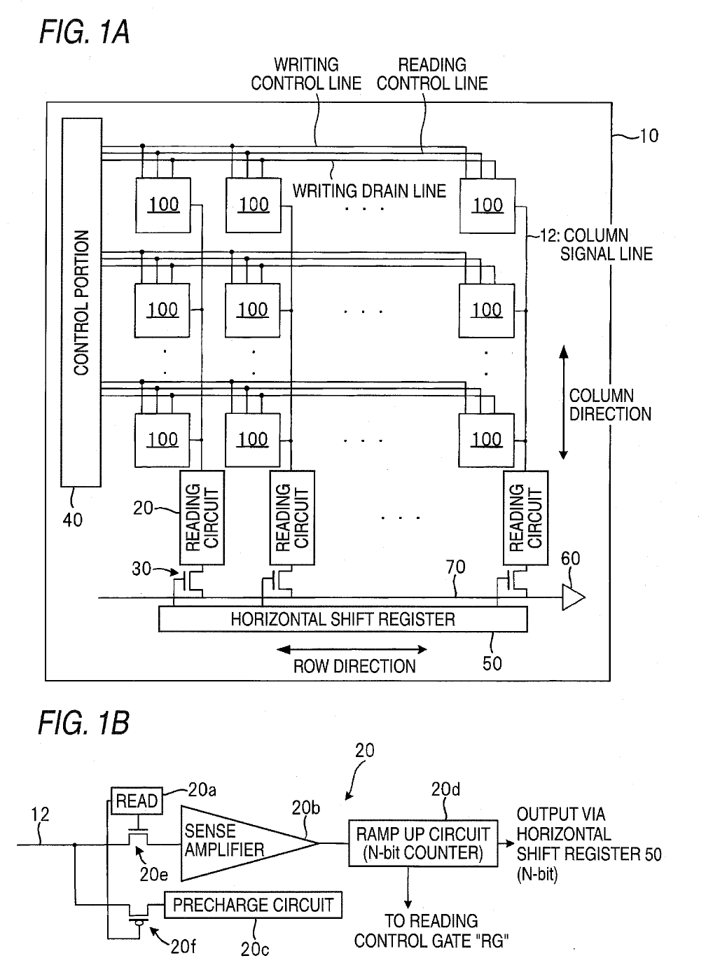

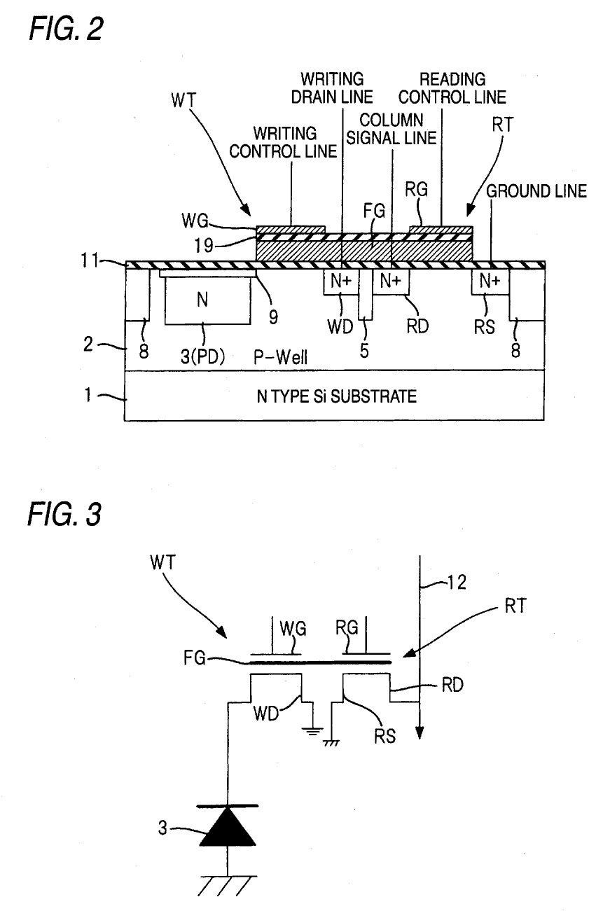

FIG. 1A is a plane view for schematically showing a structure of a solid-state imaging element 10 in order to describe the embodiment mode of the present invention. FIG. 2 is a sectional view for schematically indicating a structure of a pixel portion 100 represented in FIG. 1A. FIG. 3 is an equivalent circuit diagram of the pixel portion 100 indicated in FIG. 2.

The solid-state imaging element 10 is equipped with a plurality of pixel portions 100 which have been arranged in an array shape (in this embodiment mode, regular lattice shape) along a row direction and a column direction on the same plane, while the row direction and the column direction are intersected with each other at a right angle.

Each of the pixel portions 100 is provided with an N type silicon substrate 1 and an N type impurity layer 3 formed in such a semiconductor substrate constructed of a P well layer 2 formed on the above-described N type silicon substrate 1. The N type impurity layer 3 is formed in the P well layer 2, and since this N type impurity layer 3 and the P well layer 2 are connected to each other in a PN junction form, a photodiode (PD) is formed which functions as a photoelectric converting portion. In the below-mentioned description, the N type impurity layer 3 will be referred to as a “photoelectric converting portion 3.” The photoelectric converting portion 3 has been constructed in the form of a so-called “embedded type photodiode” in which a P type impurity layer 9 has been formed on a surface of this photoelectric converting portion 3 in order to achieve a complete depletion, and also to suppress a dark current.

A reading portion is formed on the semiconductor substrate 1, while the reading portion can read voltage signals (will also be referred as “imaging signals” hereinafter) outside the solid-state imaging element 10 in response to electric charges generated in the photoelectric converting portion 3.

The above-described reading portion is provided with a writing transistor “WT” and a reading transistor “RT.” Both the waiting transistor “WT” and the reading transistor “RT” are isolated from each other by an element isolation region 5 which is formed to be slightly separated from the photoelectric converting portion 3 on the right neighbor side. Also, structural elements of the respective pixel portions 100 within the P well layer 3 are isolated from each other by the element isolation region 8.

As element isolation methods, a LOCOS (Local Oxidation of Silicon) method, an STI (Shallow Trench Isolation) method, a high-concentration impurity ion injection method, and other methods may be applied.

The writing transistor “WT” is manufactured in the form of such a MOS transistor: That is, the MOS transistor is provided with: the photoelectric converting portion 3 functioning as a source region thereof; a writing drain “WD” corresponding to a drain region thereof constructed of an N type impurity having high concentration which is separated from the photoelectric converting portion 3 on the right side; a writing control gate “WG” corresponding to a gate electrode thereof provided between the photoelectric converting portion 3 and the writing drain “WD” via an oxide film 11 above the semiconductor substrate 1; and a floating gate “FG” thereof provided between the control gate “WG” and the oxide film 11.

As an electric conducting material which constructs the above-described writing control gate “WG”, for instance, polysilicon may be employed. Alternatively, such a doped polysilicon that phosphorus (P), arsenic (As), and boron (B) have been doped in high concentration may be employed. Otherwise, Silicide and Self-align Silicide may be alternatively employed, in which various sorts of metals such as titanium (Ti) and tungsten (W) have been combined with silicon.

The reading transistor “RT” is manufactured in the form of such a MOS transistor: That is, the MOS transistor is provided with: a reading drain “RD” corresponding to a drain region thereof constructed of an N type impurity having high concentration, which is provided on the right neighbor side of the element isolation region 5; a reading source “RS” corresponding to a source region thereof constructed of an N type impurity which is provided to be slightly separated from the reading drain “RD” at the right neighbor side, a reading control gate “RG” corresponding to a gate electrode provided between the reading drain “RD” and the reading source “RS” via the oxide film 11 above the semiconductor substrate 1; and a floating gate “FG” thereof provided between the reading control gate “RG” and the oxide film 11.

As to an electric conducting material which constructs the reading control gate “RG”, the same electric conducting material as that of the writing control gate “WG” may be employed. A column signal line 12 is connected to the reading drain “RD.” A ground line is connected to the reading source “RS.” Impurity concentration of the reading drain “RD” has been adjusted in order that the reading drain “RD” may be ohmic-contacted to the column signal line 12. Impurity concentration of the reading source “RS” has been adjusted in order that the reading source “RS” may be ohmic-contacted to the ground line.

The floating gate “FG” corresponds to an electrically floating electrode provided between the P type impurity layer 9 and the reading source “RS” via the oxide film 11 above the semiconductor substrate 1. Both the writing control gate “WG” and the reading control gate “RG” are provided on the floating gate “FG” via an insulating film 19 such as a silicon oxide. As to an electric conducting material which constructs the floating gate “FG”, the same electric conducting material as that of the writing control gate “WG” may be employed.

It should be understood that the floating gate “FG” may be formed not only in a single sheet structure which is commonly used with respect to the writing transistor “WT” and the reading transistor “RT”, but also in two separated floating gate structures. That is, while two separated floating gates “FG” are provided with respect to the writing transistor “WT” and the reading transistor “RT”, these two-separated floating gates “FG” are electrically connected to each other by a wiring line. Alternatively, in order that electric charge injections from the photoelectric converting portion 3 to the floating gate “FG” may readily occur, the writing control gate “WG” and the photoelectric converting portion 3 may be partially overlapped with each other.

The pixel portion 100 has been formed in such a structure that light is not entered to a region except for a partial region of the photoelectric converting portion 3 by a light shielding film (not shown).

The solid-state imaging element 10 is provided with a control portion 40, a reading circuit 20, a horizontal shift register 50, and an output amplifier 60. The control portion 40 controls both the writing transistor “WT” and the reading transistor “RT.” The reading circuit 20 detects a threshold voltage of the reading transistor “RT.” The horizontal shift register 50 performs a control operation in such a manner that the threshold voltages for I line detected by the reading circuit 20 are sequentially read as imaging signals to a signal line 70. The output amplifier 60 is connected to the signal line 70.

The reading circuit 20 is provided in correspondence with each of columns which are constructed by a plurality of pixel portions 100 arranged along a column direction, and is connected via the column signal line 12 to the reading drain “RD” of each of the pixel portions 100 of the corresponding column. Also, the reading circuit 20 is also connected to the control portion 40.

As indicated in FIG. 1B, the reading circuit 20 is arranged by employing a reading control unit 20a, a sense amplifier 20b, a precharge circuit 20c, a ramp up circuit 20d, and transistors 20e and 20f.

When the reading control unit 20a reads a signal from the pixel portion 100, the reading control circuit 20a turns ON the transistor 20f so as to apply a drain voltage from the precharge circuit 20c via the column signal line 12 to the reading drain “RD” of the pixel portion 100 (namely, precharge). Next, the reading control unit 20a turns ON the transistor 20e so as to conduct the reading drain “RD” of the pixel portion 100 and the sense amplifier 20b.

The sense amplifier 20b monitors a voltage appeared at the reading drain “RD” of the pixel portion 100, and detects that this monitored voltage has changed, and then, notifies the detection result to the ramp up circuit 20d. For example, the sense amplifier 20b detects that the drain voltage precharged by the precharge circuit 20c has been dropped, and thus, inverts the output signal of the sense amplifier 20b.

While the ramp up circuit 20d has contained an N-bit counter, the ramp up circuit 20d applies such a ramp waveform voltage which is gradually increased, or gradually decreased, to the reading control gate “RG” of the pixel portion 100 via the control portion 40, and outputs a counter value (namely, “N” pieces of “1” and “0” are combined with each other) which corresponds to the values of the ramp waveform voltage.

When a voltage of the reading control gate “RG” exceeds the threshold voltage of the reading transistor “RT”, the reading transistor “RT” becomes conductive. At this time, the potential of the precharged column signal line 12 is decreased. This potential drop is detected by the sense amplifier 20b, so that an inverted signal is outputted from the sense amplifier 20b. The ramp up circuit 20d holds (latches) a count value which corresponds to a voltage of a ramp waveform voltage at a time instant when this inverted voltage is received by the ramp up circuit 20d. As a result, a change (imaging signal) of threshold voltages can be read out as a digital value (combination between 1 and 0).

When one horizontal selecting transistor 30 is selected by the horizontal shift register 40, such a count value held by the ramp up circuit 20d connected to the selected horizontal selecting transistor 30 is outputted to the signal line 70, and this outputted count value is outputted as an imaging signal from the output amplifier 60.

It should also be noted that as a method for reading out a change in the threshold voltages of the reading transistor “RT” by the reading circuit 20, the present invention is not limited only to the above-described reading method. For instance, the reading circuit 20 may alternatively read such a drain current of the reading transistor “RT” as an imaging signal in the case that a constant voltage is applied to both the reading control gate “RG” and the reading drain “RD.”

The control portion 40 is connected via a writing control line, a reading control line, and a writing drain line to the writing control gate “WG”, the reading control gate “RG” and the writing drain “WD” of each of the pixel portions 100 arranged along the row direction, respectively. Impurity concentration of the writing drain “WD” has been adjusted in order that the writing drain “WD” may be ohmic-contacted to the writing drain line.

The control portion 40 controls the writing transistor “WT” so as to perform such a driving operation that electric charges generated in the photoelectric converting portion 3 are injected to the floating gate “FG” in order to store the injected electric charges into this floating gate “FG.” As methods for injecting electric charges to a floating gate “FG”, there are two electron injection methods: Namely, a CHE injection method for injecting the electric charges to the floating gate “FG” by employing channel hot electrons (CHE); and a tunnel electron injection method for injecting the electric charges to the floating gate “FG” by employing a Fowler-Nordheim (F-N) tunnel current.

Also, the control portion 40 controls the reading transistor “RT” based upon the above-explained method so as to perform such a driving operation that an imaging signal responding to the electric charges stored in the floating gate “FG” is read out.

Also, the control portion 40 performs another driving operation that the electric charges stored in the floating gate “FG” are ejected outside the pixel portion 100 so as to erase the ejected electric charges. Concretely speaking, the control portion 40 applies a voltage having a positive polarity to the substrate, and also, applies another voltage having negative polarity with respect to the writing control gate “WG” and the reading control gate “RG” respectively so as to erases the electric charges by pulling out the stored charges in the floating gate “FG” to the substrate.

It should also be understood that although the control portion 40 has been built in the solid-state imaging element 10 in FIG. 1A, the function of the control portion 40 may be alternatively provided on the side of the imaging apparatus where the solid-state imaging element 10 is mounted.

Next, a description is made of an example as to imaging operations of the solid-state imaging element 10 having the above-described structure. In the following description, a first operation example where electric charges are injected based upon the CHE injection method, and a second operation example where electric charges are injected based upon the tunnel electron injection method.

### First Operation Example

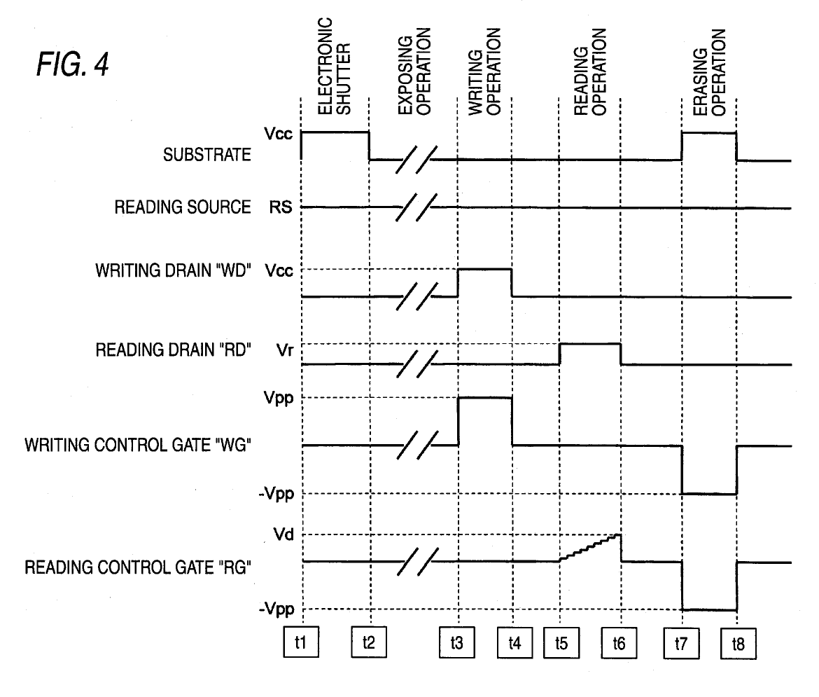

FIG. 4 is a timing chart for describing a first example as to an imaging operation of an imaging apparatus on which the solid-state imaging element 10 shown in FIG. 1A is mounted. FIG. 4 represents potential changes of respective structural portions provided in pixel portions 100 of an “i”th line in combination with a time.

Firstly, at a time instant “t1” before exposing/storing operations are commenced, as an electronic shutter operation, the control portion 40 sets a potential at the semiconductor substrate 1 to “V_{cc}” so as to eject all electric charges to the semiconductor substrate 1, which have been stored in the photoelectric converting portion 3 before the time instant “t1.” Since the above-described ejecting operation is carried out, the photoelectric converting portion 3 is brought into such a condition that no electric charge is present. Since the electric charges stored in the floating gate “FG” had been erased before the time instant “t1”, the floating gate “FG” is also reset by an erasing operation at this time instant “t1.” at this time instant “t1.” As a consequence, since the ejecting operation is carried out by the control portion 40 at the time instant “t1”, both the photoelectric converting portion 3 and the floating gate “FG” are brought into such conditions that electric charges are not stored.

At a time instant “t2” corresponding to starting timing of the exposing time period based upon the photographing condition, the control portion 40 sets the potential of the semiconductor substrate to a “Low” level. Also, at this time, the potential of the writing control gate “WG” and the potential of the writing drain “WD” are set to the “Low” levels in order that the electric charges generated in the photoelectric converting portion 3 are not injected into the floating gate “FG” by the writing transistor “WT.” Since such a voltage setting operation is carried out, the electric charges generated in the photoelectric converting portion 3 during the exposing time period are directly stored in the photoelectric converting portion 3. Also, since the potential of the writing drain “WD” has been set to the “Low” level, a dark current produced in the writing drain “WD” becomes small. Further, since the potential of the writing control gate “WG” has also been set to the “Low” level, the above-described dark current is not injected to the floating gate “FG”, but also noises are not mixed into the floating gate “FG.”

At a timing “t3” corresponding to end timing (namely, starting timing of writing time period) of the above-described exposing time period, the control portion 40 sets the potentials at the writing control gates “WG” of all of the pixel portions 100 to Vₚₚ (>V_{cc}) and also, sets the potentials at the writing drains “WD” thereof to “V_{cc}.” Since such voltage setting operations are carried out, the electric charges which have been stored in the photoelectric converting portions 3 during the exposing time period pass through the oxide film 11, and then, are injected into the floating gates “FG” (CHE injection). It should be understood that the control portion 40 sets the potentials of the reading drains “RD” of all of the pixel portions 100 to “Low” levels in order to suppress that electric charges are leaked from the reading drains “RD.” As a result, it is possible to avoid that the sensitivity is lowered.

It should also be noted that there is such a risk that noises caused by dark currents produced from the writing drains “WD” are injected to the floating gate “FG” within a writing time period defined from the time instant “t3” to a time instant “t4.” However, the writing time period may be made sufficiently shorter than the exposing time period, so that the noises caused by the dark currents produced during this writing time period can become negligibly small.

As previously explained, during the exposing time period defined from the time instant “t2” to the time instant “t3”, the electric charges are stored at the same time in all of the pixel portions 100. Also, during the writing time period defined from the time instant “t3” to the time instant “t4”, the electric charges are injected at the same time into the floating gates “FG” in all of the pixel portions 100. It should also be understood that the film thickness and the like of the oxide film 11 have been adjusted in order that the electric charges which have been stored in the photoelectric converting portion 3 may be quickly and firmly injected into the floating gates “FG.”

At the time instant “t4” corresponding to end timing of the writing time period, the control portion 40 sets the potentials at the writing control gates “WG” and the potentials at the writing drains “WD” of all of the pixel portions 100 to “Low” levels, respectively. As a result, electric charges which are generated in the photoelectric converting portions 3 of all of the pixel portions 100 after the time instant “t4” will not be injected to the floating gates “FG”, so that the writing operations of the electric charges are accomplished.

At a time instant “t5” corresponding to starting timing of a reading time period for an imaging signal, the control portion 40 sets a potential at a reading drain “RD” of each of the pixel portions 100 of an “i”th line to V, (<V_{cc}), and commences to apply a ramp waveform voltage to a reading control gate “RG” of each of the pixel portions 100 of the “i”th line.

Then, count values are held in the respective reading circuits 20, and the held count values are outputted as an imaging signal from the output amplifier 60, while these count values correspond to values of ramp waveform voltages at such a time instant when the potentials at the reading drains “RD” of the “i”th line are lowered.

The control portion 40 performs the signal reading operations defined from the time instant “t5” to the time instant “t6” by shifting the timing every line. Since the signal reading operations are carried out every line, the reading wait time periods defined from the time instant “t4” up to the time instant “t5” are made different from each other every line, and thus, the wait time period in the longest line may become such a time period which considerably exceeds 1 msec. As a consequence, the structure of the oxide film 11 has been adjusted in order that leaking of the electric charges does not occur in the exposing time period, the writing time period, and the reading wait time period.

After the imaging signals have been sequentially read out from all of the pixel portions 100, the control portion 40 sets the potentials at the writing control gates “WG” and the potentials at the reading control gates “RG” as to all of the pixel portions 100 to “−Vₚₚ”, and sets the potential of the semiconductor substrate to “V_{cc}” (time instant “t7”). As a result, the electric charges which have been stored in the floating gates “FG” are pulled out to the semiconductor substrate so as to be erased.

### Second Operation Example

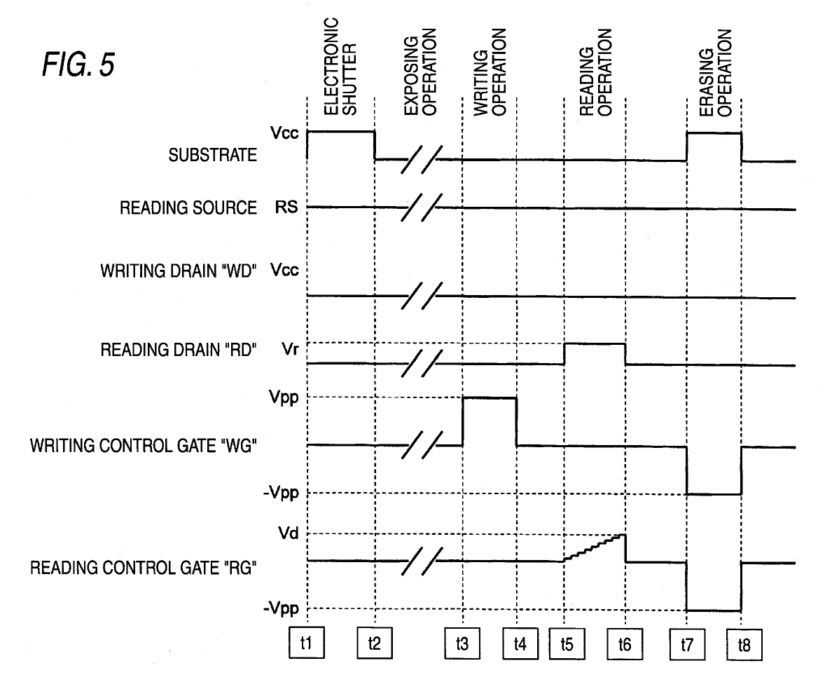

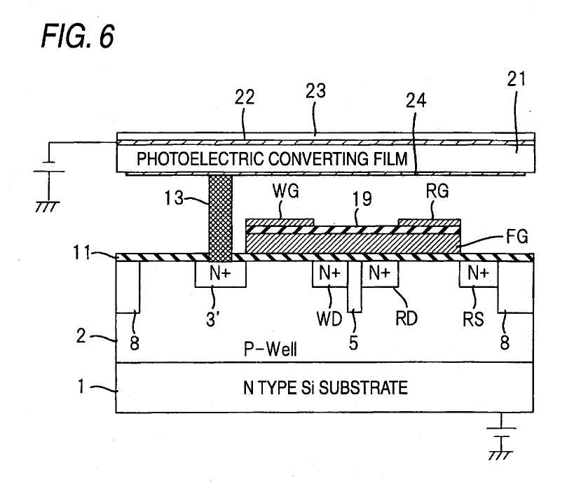

FIG. 5 is a timing chart for explaining a second example as to an imaging operation of an imaging apparatus on which the solid-state imaging element shown in FIG. 1 is mounted. In FIG. 5, potential changes of respective structural portions in the pixel portions 100 of the “i”th line have been represented in combination with time. The timing chart of FIG. 5 has only such a different point from the timing chart of FIG. 4 that a potential of a writing drain “WD” has been set to a “Low” level during a writing time period. As a result, electric charges generated in the photoelectric converting portion 3 are injected into the floating gate “FG” by an F-N tunnel current.

As previously described, in accordance with the above-explained imaging apparatus, since injecting of the electric charges into the floating gate “FG” is not carried out during the exposing time period, such a possibility that noises produced during the exposing time period are mixed in the floating gate “FG” can be lowered. Also, injecting of the electric charges into the floating gate “FG” which have been generated during the exposing time period can be carried out within a sufficiently shorter time than the exposing time period. As a consequence, mixing of the noises into the floating gate “FG” within a time period (namely, writing time period) during which the electric charges are injected can be reduced to a negligibly low noise. As a result, the imaging operation with the high image quality can be carried out, while suppressing the noises.

In accordance with the imaging apparatus described in JP-A-2002-280537, the noises which are mixed into the floating gates “FG” are defined by (N−{exposing time period−(a portion of exposing time period)}), whereas in accordance with the above-explained imaging apparatuses, the noises which are mixed into the floating gates “FG” are defined by (N× writing time period). As a result, the noise amounts of the last-mentioned imaging apparatuses can be reduced. In particular, when a long-time exposing operation is carried out during which an exposing time period becomes long, the noise reducing effect can become conspicuous. As a consequence, if the driving methods are selectively switched in response to photographing conditions in the below-mentioned manner, then the more effective result may be achieved: That is, when the long-time exposing operation is carried out, the driving method indicated in FIG. 4, or FIG. 5 is performed in order to reduce the noises with top priority, whereas when the normal exposing operation is carried out, the same driving method as the conventional driving method (namely, in conventional driving method, both exposing operation and writing operation are simultaneously carried out) in order to increase the photographing process speed with top priority.

Also, in accordance with the above-described imaging apparatuses, since the driving method for injecting the electric charges to the floating gates “FG” is employed based upon the CHE injection, the injection speed of the electric charges can be improved. Further, since the driving method for injecting the electric charges to the floating gates “FG” is employed based upon the tunnel electron injection, it is possible to suppress that the dark current is produced from the writing drains “WD” within the time period during which the electric charges are stored in the floating gates “FG”, so that such an image having a higher image quality can be provided which contains a smaller amount of noises.

It should also be noted that the above-explained description has exemplified such a structure that the pixel portion 100 contains two sets of the writing transistor “WT” and the reading transistor “RT.” Alternatively, the function of the writing transistor “WT” and the function of the reading transistor “RT” may be realized by employing a single transistor.

For instance, in FIG. 2, another structure may be alternatively constructed in which the reading transistor “RT” may be omitted, and the reading circuit 20 may be connected via the column signal line 12 to the writing drain “WD.” In the case of the above-described alternative structure, during the exposing time period, while the potentials of both the writing control gate “WG” and the writing drain “WD” are kept in the “Low” level and the injection of the electric charges to the floating gate “FG” is stopped, the electric charges are stored into the photoelectric converting portion 3. Then, in the writing time period, the potential of the writing control gate “WG” is set to “Vₚₚ”, and also, the potential of the writing drain “WD” is set to either “V_{cc}” or the “Low” level in order that the electric charges are written in the floating gate “FG.” Also, in the signal reading time period, the potential of the writing drain “WD” is set to “Vᵣ”, and also, the ramp waveform voltage is applied to the writing control gate “WG” in order that the imaging signal is read out. Also, in the electric charge erasing time period, the potential of the semiconductor substrate is set to “V_{cc}”, and the potential of the writing control gate “WG” is set to “−Vₚₚ” in order that the electric charges are pulled out to the semiconductor substrate.

What is claimed is:

1. An imaging apparatus which includes a solid-state imaging element comprising:
a photoelectric converting element;
an electric charge storage portion provided above a semiconductor substrate which stores thereinto electric charges generated in the photoelectric converting portion;
a transistor which injects the electric charges generated in the photoelectric converting portion into the electric charge storage portion; and
a driving unit which drives the transistor in such a manner that injecting of the electric charges generated in the photoelectric converting portion into the electric charge storage portion is stopped during an exposing time period, and after the exposing time period has accomplished, the electric charges generated in the photoelectric converting portion during the exposing time period are injected into the electric charge storage portion.

2. The imaging apparatus according to claim 1, wherein the solid-state imaging element is further comprised of a reading transistor which reads a signal which responds to the electric charges stored in the electric charge storage portion;
the electric charge storage portion corresponds to a floating gate; and
the floating gate in the transistor is electrically connected to the floating gate in the reading transistor.

3. The imaging apparatus according to claim 1, wherein the driving unit drives the transistor in such a manner that the electric charges are injected based upon a channel hot electron injection.

4. The imaging apparatus according to claim 1, wherein the driving unit drives the transistor in such a manner that the electric charges are injected based upon a tunnel electron injection.

5. The imaging apparatus according to claim 1, wherein the photoelectric converting portion is a photoelectric converting film provided above the semiconductor substrate.

6. The imaging apparatus according to claim 5, wherein the photoelectric converting film is constructed by amorphous silicon, a CIGS (copper, indium, gallium, selenium)-series material, or an organic material.

7. A driving method of a solid-state imaging element having: a photoelectric converting element; an electric charge storage portion provided above a semiconductor substrate which stores thereinto electric charges generated in the photoelectric converting portion; a transistor which injects the electric charges generated in the photoelectric converting portion into the electric charge storage portion; the method comprising,
driving the transistor in such a manner that injecting of the electric charges generated in the photoelectric converting portion into the electric charge storage portion is stopped during an exposing time period, and after the exposing time period has accomplished, the electric charges generated in the photoelectric converting portion during the exposing time period are injected into the electric charge storage portion.

8. The driving method of the solid-state imaging element according to claim 7, wherein the solid-state imaging element is further comprised of a reading transistor which reads a signal which responds to the electric charges stored in the electric charge storage portion;
the electric charge storage portion corresponds to a floating gate; and
the floating gate in the transistor is electrically connected to the floating gate in the reading transistor.

9. The driving method of the solid-state imaging element according to claim 7, wherein in the driving, the transistor is driven in such a manner that the electric charges are injected based upon a channel hot electron injection.

10. The driving method of the solid-state imaging element according to claim 7, wherein in the driving, the transistor is driven in such a manner that the electric charges are injected based upon a tunnel electron injection.

11. The driving method of the solid-state imaging element according to claim 7, wherein the photoelectric converting portion is a photoelectric converting film provided above the semiconductor substrate.

12. The driving method of the solid-state imaging element according to claim 11, wherein the photoelectric converting film is constructed by amorphous silicon, a CIGS (copper, indium, gallium, selenium)-series material, or an organic material.
